(19) United States
(12) Patent Application Publication
(10) Pub. No.: US 2010/0119291 A1
(43) Pub. Date: May 13, 2010

(54) Writing utensil with two handles for writing with both hands simultaneously

(76) Inventor: Dorin Kalif, Tel Aviv (IL)

Correspondence Address: DORIN KALIF, P.O. Box 29746, Tel Aviv, 61297, IL

(21) Appl. No.: 12/591,080

(22) Filed: Nov. 6, 2009

Related U.S. Application Data
(60) Provisional application No. 61/198,705, filed on Nov. 10, 2008.

(51) Int. Cl. B43K 29/00

(52) U.S. Cl. 401/195

(57) ABSTRACT

The present invention refers to a writing utensil with two handles that enables the user to grip the said writing utensil with both hands when writing. In addition, the invention refers to a handle comprised of a central body that is shaped like a hollow cylinder into which a standard writing utensil is inserted, and that has two handles.

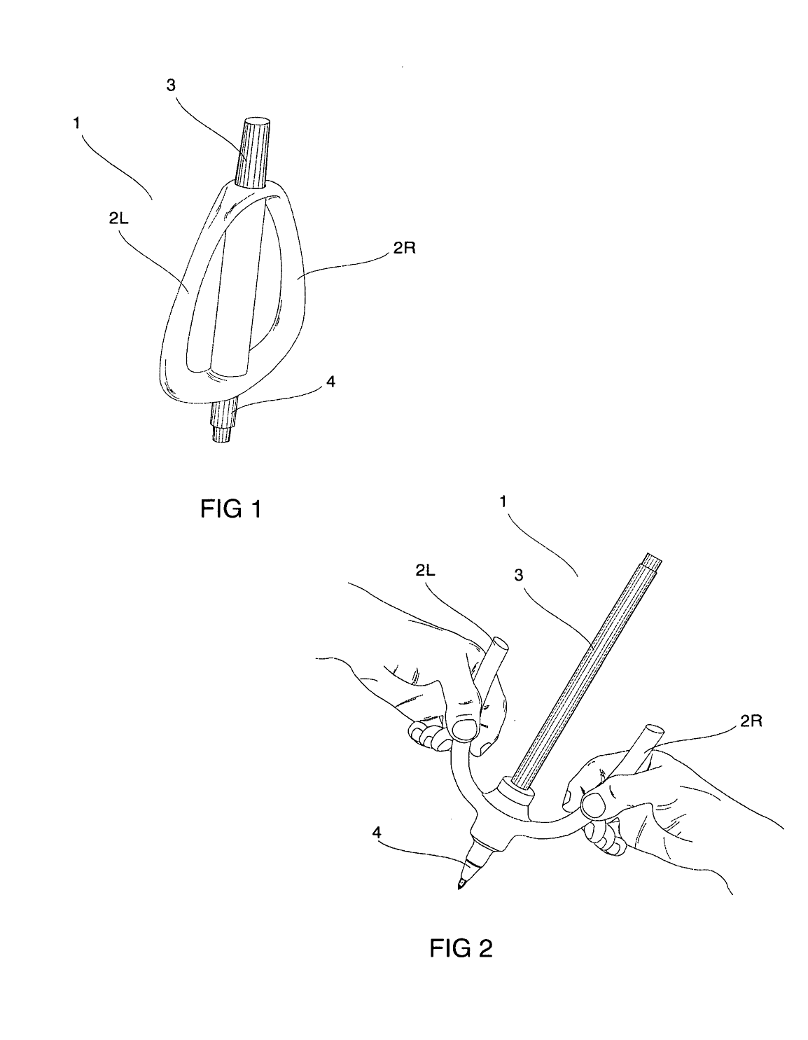

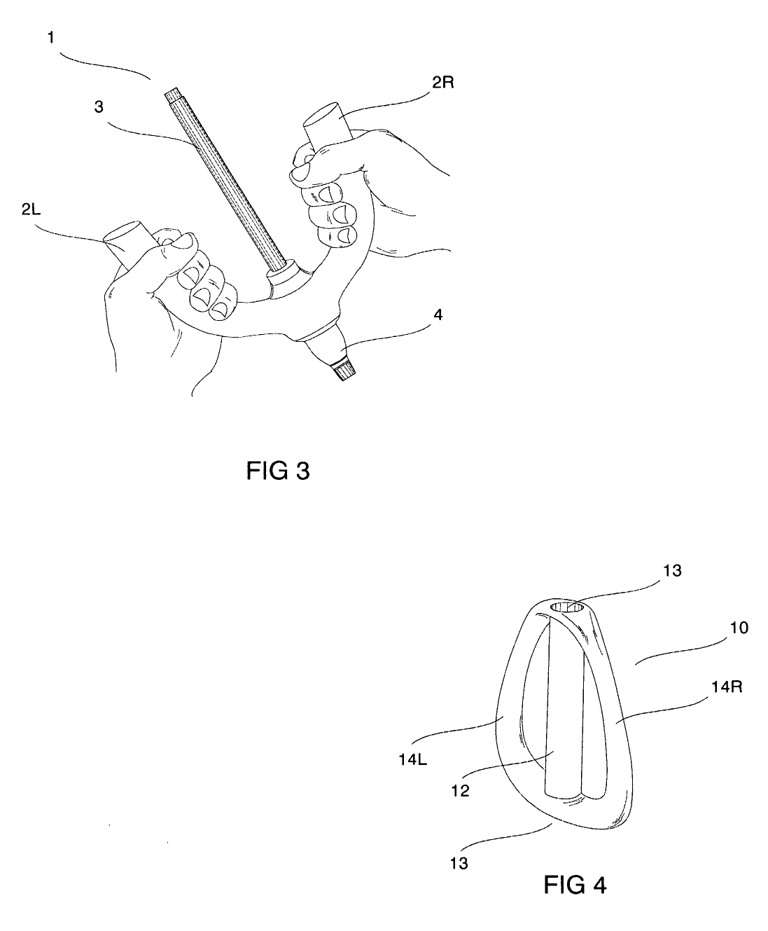

### RELATED APPLICATIONS

Priority is claimed based on U.S. Provisional Patent Application 61/198,705 filed on 10 Nov. 2008.

### TECHNICAL FIELD

The present invention refers to a writing utensil with two handles, whereby the user writes while gripping the writing utensil with two hands simultaneously.

### BACKGROUND ART

Operations that a person executes using his or her hands are controlled mainly by the brain, and it is also known that such operations are assimilated into the brain. The use of each of our hands is controlled by and assimilated into the opposite side of the brain (in other words, the use of the right hand is mainly influenced by and assimilated into the left-hand side of the brain, and vice versa). These principles are known to all specialists engaged in brain research and in the study of mutual, reciprocal influences between hand action and brain action. Mutual influence between the brain and the hands also exists when we use writing utensils, such as a pen or pencil (mainly when we write or draw). The present invention refers to a writing utensil designed to be used with both hands simultaneously.

### The Invention

The present invention refers to a writing utensil (1) with two handles (2L) (2R), whereby the user grips the writing utensil (1) with both hands while writing. The writing utensil (1) can be a pen, a pencil, a marker, and so on, and for convenience sake only we will use the word “pen” here to refer to the writing utensil (1), subject of the invention. In addition, the word “pen” in this patent application also refers to other kinds of writing utensil such as sticks (that do not include ink or any other painting materials) that are used for ‘writing’ on a computer touch screen, playing boards and such kind of articles.

The first embodiment of the present invention refers to a pen (1) that comprises a central core (3), which is actually the body of the pen (1) and a bottom tip (4), which is the part that actually writes. Two handles (2L) (2R) protrude from either side of the central core (3). The user grips the pen (1) with both hands, holding one handle (2R) with the right hand and the other handle (2L) with the left hand.

Drawing No. 1 depicts the handles (2R) (2L), which are shaped like a closed arc. Nevertheless, it is emphasized that the handles (2L) (2R) can be made in a large variety of shapes and the depiction of the handles (2L) (2R) in Drawing No. 1 does not limit the scope of the implementation of the invention and its protection. Drawing No. 2 depicts the pen (1) whereby the two handles (2L) (2R) are shaped like open arms that are attached to the central core (3) of the pen (1) and extend outwards, curving upward. In addition, the handles (2L) (2R) can come in a variety of sizes. Drawing No. 3 depicts a pen (1) with relatively large handles (2L) (2R).

The second embodiment of the present invention refers to a handle (10), a general view of which is depicted in Drawing No. 4. The handle is designed so as to be inserted over a standard writing utensil (such as a pen, a pencil, a marker, and so on). The handle (10) together with the standard writing utensil constitute the aforementioned pen (1), subject of the first embodiment of the invention. The handle (10) comprises a central part (12) that is shaped like a cylinder with a vertical cavity (13) and two arms (14R) (14L). The standard pen is inserted into the cavity (13). The shape of the cavity (13) and the materials that the handle (10) is made of cause the standard pen to fit snuggly into the handle (10) and thus facilitate the writing operation.

Using the pen (1) can solve and even prevent the development of writing-related problems that occur particularly in children. We mention here two examples of such problems: (a) Children who for various physiological and environmental considerations have yet to choose a dominant writing hand; and (b) children who have chosen a dominant writing hand that is not the hand designated for writing in terms of their innate brain lobe designation. These are the underlying causes of many of the problems children have in the acquisition of learning skills. The source of these problems may be diagnosable factors [such as a lazy eye (amblyopia), squinting, and motor skill deficiencies] or latent factors that are unknown even to scientists.

Using the pen (1), subject of the invention, encourages focusing of vision and creates hand-eye coordination involving both eyes and both hands simultaneously. This prevents the child from choosing the “wrong” hand for writing, which is the main cause of writing problems. Using the pen (1) also connects the two sides of the brain and alleviates problems created by using the “wrong” hand. Using the pen (1), or in other words writing with both hands, enables the child to sit in a symmetric position in which the body is not leaning in any one direction. This contributes to maximum comfort when writing and enhances the writer's mental concentration and focus, leading in turn to more efficient learning through writing.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

### DESCRIPTION OF THE DRAWINGS

Drawings Nos. 1 through 3 depict the pen (1).

Drawing No. 4 depicts the handle (10).

What is claimed is:

1. A writing utensil with two handles that enables the user to grip the said writing utensil with both hands when writing.

2. A handle comprised of a central body, shaped like a hollow cylinder, into which a standard writing utensil is inserted, and two handles.
